(19) United States
(12) Patent Application Publication
(10) Pub. No.: US 2026/0358042 A1
(43) Pub. Date: Nov. 12, 2026

(54) HOUSEHOLD APPLIANCE CAMERA VIEWING ANGLE ADJUSTMENT

(71) Applicant: Haier US Appliance Solutions, Inc., Wilmington, DE (US)

(72) Inventors: Jinmo Chong, Seoul (KR); Intae Kim, Seoul (KR); Jongdeok Jang, Incheon (KR); Jae Ho Ahn, Seoul (KR); Jaewon Jo, Seongnam-si (KR); Jaebong Lee, Seongnam-si (KR)

(21) Appl. No.: 19/200,776

(22) Filed: May 7, 2025

(51) Int. Cl. F25D 29/00; F25D 23/02; F25D 23/12; G06F 3/16; H04N 23/695

(52) U.S. Cl. CPC F25D 29/005; F25D 23/028; F25D 23/12; G06F 3/167; H04N 23/695; F25D 2400/361; F25D 2700/06

(57) ABSTRACT

A refrigerator includes a cabinet defining a chamber, a door rotatably hinged to the cabinet, and a camera mounted to the cabinet that captures images of the chamber upon activation. Additionally, the refrigerator includes a mirror assembly positioned within the chilled chamber that includes a frame and a mirror plate with a mirror mounted thereon. The plate is coupled to the frame and movable between retracted and fully extended positions. Furthermore, the assembly includes an actuator operably coupled to the plate and contacted by the door while the door is closed. Movement of the door moves the actuator. Moreover, the assembly includes a pair of scissor arms coupled between the plate and actuator. The pair of scissor arms moves the plate between the fully extended position and the retracted position as movement of the door moves the actuator.

### FIELD

The present subject matter relates generally to household appliances, such as refrigerator appliances, and more particularly to adjustment of the viewing angle of cameras of household appliances.

### BACKGROUND

Household appliances are utilized generally for a variety of tasks by a variety of users. For example, a household may include such appliances as laundry appliances, e.g., a washer and/or dryer, kitchen appliances, e.g., a refrigerator, an oven, etc., along with other various appliances. Some household appliances may include imaging systems or camera assemblies which capture various images, e.g., still images and/or video in and around the appliance. For example, such systems may be used to identify and track objects added to or removed from the appliance, such as food items in a refrigerator appliance or oven appliance, or laundry articles in a washing machine appliance or dryer appliance.

Images and/or videos captured by such household appliances generally include object(s) of interest, e.g., food items or laundry articles, which are moved within, into, or out of the household appliance. Sometimes, the images and/or videos may not be captured at a desirable angle. For example, the images and/or videos may capture background information, such as parts of the appliance itself or static objects, in addition to the object(s) of interest and/or may not capture the desired object(s) of interest.

Accordingly, a household appliance with features for resolving one or more of the above-mentioned drawbacks would be useful.

### BRIEF DESCRIPTION

Aspects and advantages of the invention will be set forth in part in the following description, or may be apparent from the description, or may be learned through practice of the invention.

In an exemplary embodiment, a refrigerator appliance is provided. The refrigerator appliance includes a cabinet. The cabinet defines a chilled chamber. Additionally, the refrigerator appliance includes a door. The door is rotatably hinged to the cabinet to provide selective access to the chilled chamber. Furthermore, the refrigerator appliance includes a camera. The camera is mounted to the cabinet, whereby the camera captures one or more images of the chilled chamber upon activation. Moreover, the refrigerator appliance includes a mirror assembly. The mirror assembly is positioned within the chilled chamber. The mirror assembly includes a frame. Additionally, the mirror assembly includes a mirror plate including a mirror mounted thereon. The mirror plate is coupled to the frame and is movable between a retracted position in which the mirror plate is nested within the frame and a fully extended position in which the mirror plate protrudes out of the frame. Furthermore, the mirror assembly includes an actuator. The actuator is operably coupled to the mirror plate and is contacted by the door while the door is closed. Movement of the door moves the actuator. Moreover, the mirror assembly includes a pair of scissor arms. The pair of scissor arms is coupled between the mirror plate and the actuator, whereby the pair of scissor arms moves the mirror plate between the fully extended position and the retracted position as movement of the door moves the actuator.

In another exemplary embodiment, a refrigerator appliance is provided. The refrigerator appliance includes a cabinet. The cabinet defines a chilled chamber. Additionally, the refrigerator appliance includes a door. The door is rotatably hinged to the cabinet to provide selective access to the chilled chamber. Furthermore, the refrigerator appliance includes a camera. The camera is mounted to the cabinet, whereby the camera captures one or more images of the chilled chamber upon activation. Moreover, the refrigerator appliance includes a mirror assembly. The mirror assembly is positioned within the chilled chamber. The mirror assembly includes a frame. The frame defines a linear slot. Additionally, the mirror assembly includes a mirror plate including a mirror mounted thereon. The mirror plate is coupled to the frame and is movable between a retracted position in which the mirror plate is nested within the frame and a fully extended position in which the mirror plate protrudes out of the frame. Furthermore, the mirror assembly includes an actuator. The actuator is operably coupled to the mirror plate and is contacted by the door while the door is closed. The actuator is guided by the linear slot along a linear direction during movement of the door.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter.

FIG. 2 provides a perspective view of the refrigerator appliance of FIG. 1.

FIG. 3 provides a front view of the refrigerator appliance of FIG. 1 with doors thereof in an open position.

FIG. 4 provides a front view of another exemplary refrigerator appliance with doors thereof in an open position according to one or more additional exemplary embodiments of the present subject matter.

FIG. 5 provides a perspective view of an exemplary mirror assembly for use with a refrigerator appliance, such as the refrigerator appliance of FIG. 1, particularly showing a mirror plate of the mirror assembly in a retracted position.

FIG. 6 provides a perspective view of the mirror assembly of FIG. 5, particularly showing the mirror plate of the mirror assembly in a fully extended position.

FIG. 7 provides a side partially cross-sectional view of an exemplary refrigerator appliance, such as the refrigerator appliance of FIG. 1, with the mirror assembly of FIG. 5 mounted within the refrigerator appliance and shown in the retracted position.

FIG. 8 provides a side partially cross-sectional view of an exemplary refrigerator appliance, such as the refrigerator appliance of FIG. 1, with the mirror assembly of FIG. 5 mounted within the refrigerator appliance and shown in the fully extended position.

FIG. 9 provides a flow diagram of an exemplary method for operating a refrigerator appliance according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

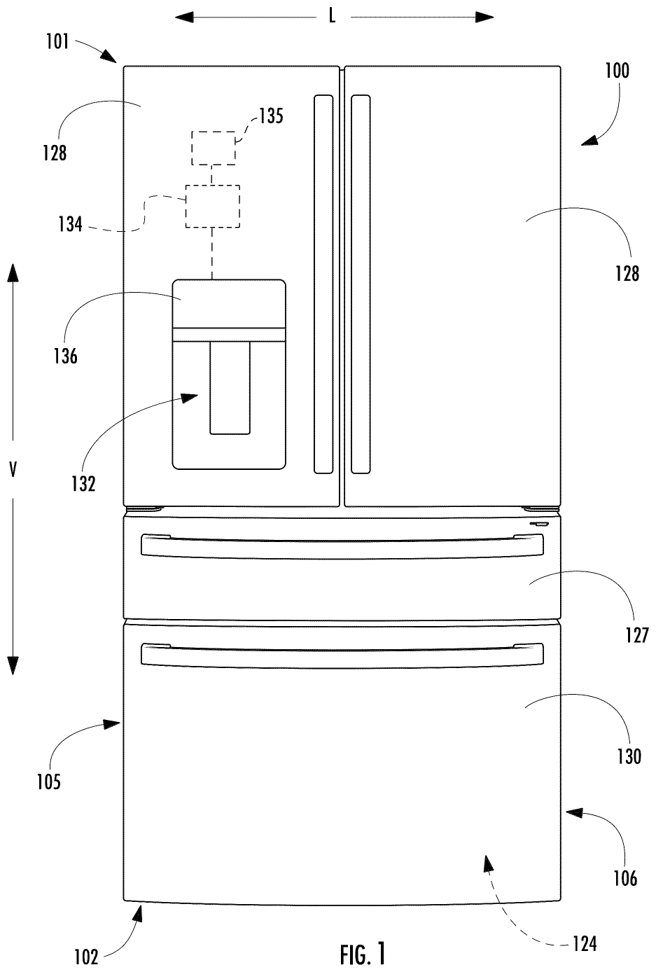

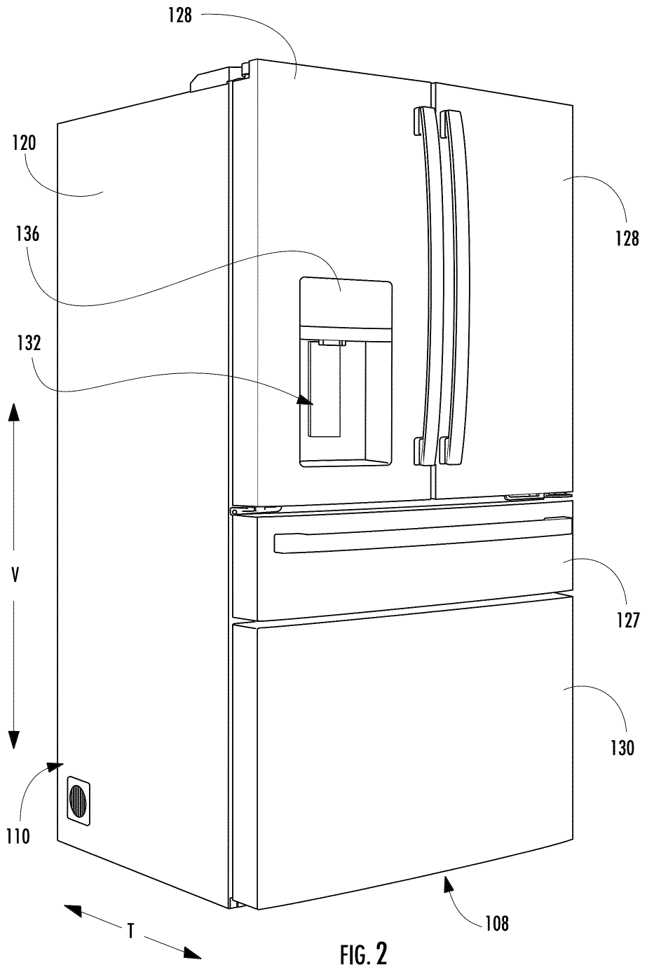

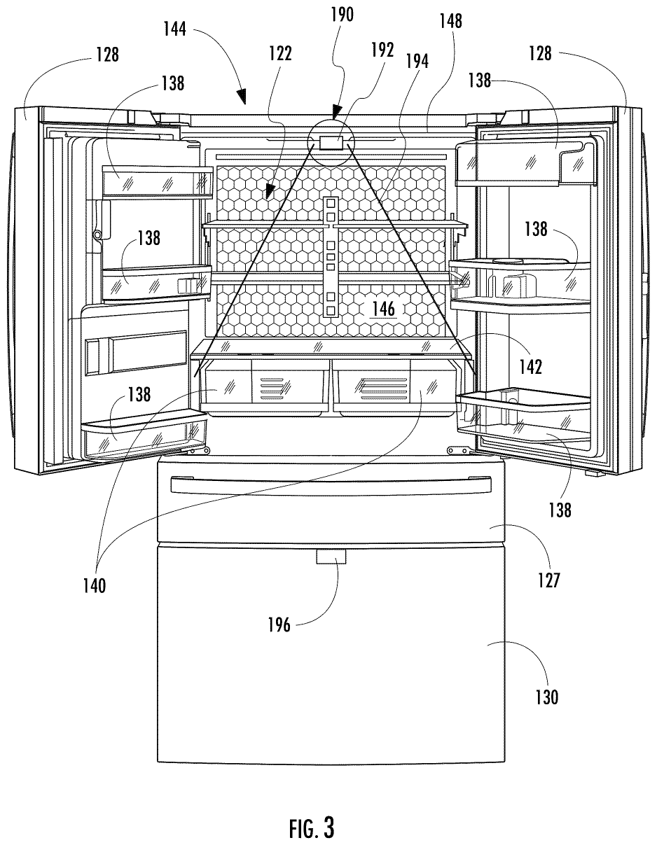

FIG. 1 is a front view of an exemplary embodiment of a refrigerator appliance 100. FIG. 2 is a perspective view of the refrigerator appliance 100. FIG. 3 is a front view of the refrigerator appliance 100 with fresh food doors 128 thereof in an open position. Refrigerator appliance 100 extends between a top 101 and a bottom 102 along a vertical direction V. Refrigerator appliance 100 also extends between a first side 105 and a second side 106 along a lateral direction L. As shown in FIG. 2, a transverse direction T may additionally be defined perpendicular to the vertical and lateral directions V and L. Refrigerator appliance 100 extends along the transverse direction T between a front portion 108 and a back portion 110.

Directional terms such as “left” and “right” are used herein with reference to the perspective of a user standing in front of the refrigerator appliance 100 to access the refrigerator and/or items stored therein. Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

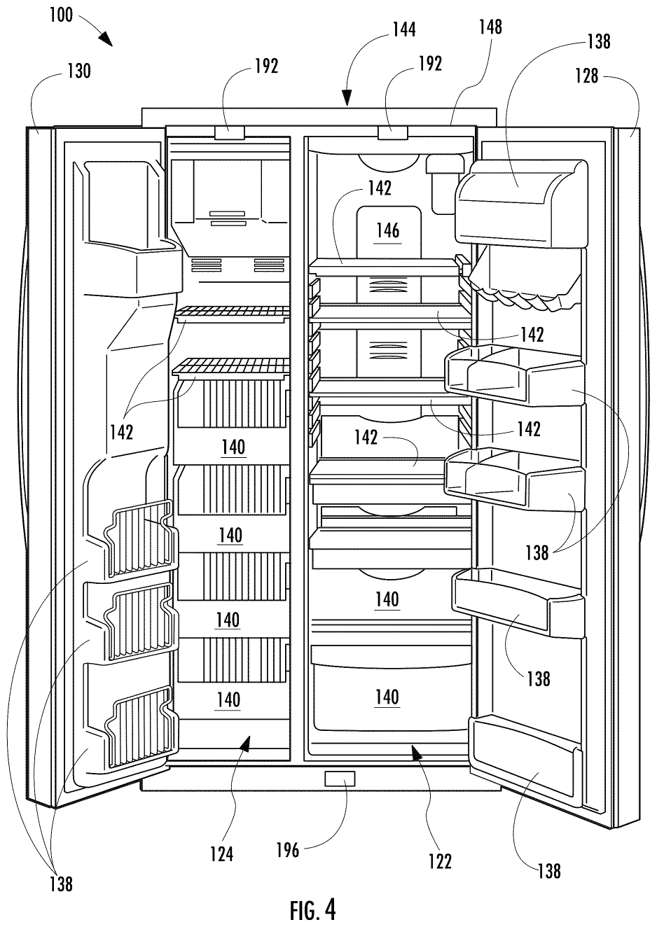

Refrigerator appliance 100 includes a cabinet or housing 120 defining one or more chilled chambers, such as an upper fresh food chamber 122 (FIG. 3) and a lower freezer chamber or freezer chamber 124 arranged below the fresh food chamber 122 along the vertical direction V. As may be seen in FIGS. 3 and 4, a plurality of food storage elements, such as bins 138, shelves 142, and drawers 140, are disposed within the fresh food chamber 122. In some embodiments, an auxiliary food storage chamber (not shown) may be positioned between the fresh food chamber 122 and the freezer chamber 124, e.g., along the vertical direction V. Because the freezer chamber 124 is positioned below the fresh food chamber 122, refrigerator appliance 100 is generally referred to as a bottom mount refrigerator. In the exemplary embodiment, cabinet 120 also defines a mechanical compartment (not shown) for receipt of a sealed cooling system (not shown). Using the teachings disclosed herein, one skill in the art will understand that the present invention can be used with other types of refrigerators (e.g., side-by-sides, such as the exemplary side-by-side configuration illustrated in FIG. 4) as well. Consequently, the description set forth herein is for illustrative purposes only and is not intended to limit the invention in any aspect.

The fresh food doors 128 are each rotatably hinged to an edge of cabinet 120 for accessing fresh food chamber 122. As may be seen in FIGS. 3 and 4, the fresh food chamber 122 extends along the transverse direction T between a front portion 144 and a back portion 146. The front portion 144 of the fresh food chamber 122 defines an opening 148 for receipt of food items. The fresh food doors 128 are rotatably mounted, e.g., hinged, to an edge of cabinet 120 for selectively accessing fresh food chamber 122. The fresh food doors 128 may be mounted to the cabinet 120 at or near the front portion 144 of the fresh food chamber 122 such that the fresh food doors 128 rotate between a closed position (FIGS. 1 and 2) where the fresh food doors 128 cooperatively sealingly enclose the fresh food chamber 122 and a fully open position (FIGS. 3 and 4) to permit access to the fresh food chamber 122. It should be noted that while two fresh food doors 128 in a “French door” configuration are illustrated in FIG. 3, any suitable arrangement of doors utilizing one, two or more doors is within the scope and spirit of the present disclosure, such as a single fresh food door 128 at the fresh food chamber 122 as illustrated in FIG. 4. A freezer door 130 for accessing freezer chamber 124 is arranged below the fresh food doors 128 in some embodiments, e.g., as illustrated in FIG. 3, or beside the fresh food door 128 in some embodiments, e.g., as illustrated in FIG. 4, or may also be located in other arrangements, e.g., above fresh food door(s) 128. In the exemplary embodiment illustrated in FIG. 3, freezer door 130 is coupled to a freezer drawer (not shown) slidably mounted within freezer chamber 124, while the exemplary freezer door 130 in the embodiment illustrated in FIG. 4 is rotatable coupled to the cabinet 120. An auxiliary door 127 may be coupled to an auxiliary drawer (not shown) which is slidably mounted within the auxiliary chamber (not shown).

Operation of the refrigerator appliance 100 can be regulated by a controller 134 that is operatively coupled to a user interface panel 136. User interface panel 136 provides selections for user manipulation of the operation of refrigerator appliance 100 to modify environmental conditions therein, such as temperature selections, etc. In some embodiments, user interface panel 136 may be proximate a dispenser assembly 132. User interface panel 136 provides selections for user manipulation of the operation of refrigerator appliance 100 such as, e.g., temperature selections, selection of automatic or manual override humidity control (as described in more detail below), etc. In response to user manipulation of the user interface panel 136, the controller 134 operates various components of the refrigerator appliance 100. Operation of the refrigerator appliance 100 can be regulated by the controller 134, e.g., controller 134 may regulate operation of various components of the refrigerator appliance 100 in response to programming and/or user manipulation of the user interface panel 136.

The controller 134 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 134 as disclosed herein are capable of and may be operable to perform any methods and associated method steps as disclosed herein.

The controller 134 may be positioned in a variety of locations throughout refrigerator appliance 100. In the illustrated embodiment, the controller 134 may be located within the fresh food door 128. In such an embodiment, input/output (“I/O”) signals may be routed between the controller and various operational components of refrigerator appliance 100. In one embodiment, the user interface panel 136 may represent a general purpose I/O (“GPIO”) device or functional block. In one embodiment, the user interface panel 136 may include input components, such as one or more of a variety of electrical, mechanical or electro-mechanical input devices including rotary dials, push buttons, and touch pads. The user interface panel 136 may include a display component, such as a digital or analog display device designed to provide operational feedback to a user. For example, the user interface panel 136 may include a touchscreen, e.g., liquid crystal display (LCD) touchscreen, providing both input and display functionality. The user interface panel 136 may be in communication with the controller via one or more signal lines or shared communication busses.

As will be described in more detail below, refrigerator appliance 100 may further include features that are generally configured to detect or monitor objects of interest, e.g., food items, in or around the refrigerator appliance 100, such as detecting food items added to or removed from an inventory of the refrigerator appliance 100. More specifically, such features may include one or more sensors, e.g., cameras 192 and/or 196 (see, e.g., FIGS. 3 and 4), or other detection devices that are used to monitor the refrigerator appliance 100 and an area in front of the cabinet 120 that is contiguous with a food storage chamber, e.g., the fresh food chamber 122 and/or freezer chamber 124, such as an area in which food items are likely to be present, e.g., an area through which the food items may travel while entering the refrigerator appliance or being removed from the refrigerator appliance. In this regard, the refrigerator appliance 100 may use data from each of these sensors or other detection devices to obtain a representation or knowledge of the identity, position, and/or other qualitative or quantitative characteristics of one or more objects of interest, such as food items.

As shown schematically in FIGS. 3 and 4, the detection system may include a camera assembly 190, that is generally positioned and configured for obtaining images of refrigerator appliance 100 and adjoining areas, e.g., in front of the refrigerator appliance 100, during operation of the camera assembly 190. For example, the camera assembly may be configured for obtaining video of the refrigerator appliance 100 and adjoining areas, such that references herein throughout to images, such as in “obtaining images,” “capturing images,” or “analyzing images,” etc., are to be understood as including images that are frames of one or more videos.

The camera assembly 190, or each camera assembly in embodiments where more than one camera assembly is provided, may include one or more cameras. According to the illustrated embodiments in FIGS. 3 and 4, camera assembly 190 includes one or more first cameras 192 and one or more second cameras 196. The first camera 192 and second camera 196 may be configured and operable to receive and record varying types of images. For example, the first camera 192 (FIG. 3) or first cameras 192 (FIG. 4) may be a photo camera or cameras, operable to receive and record or capture images based on light having wavelength(s) within the visible light spectrum, while the second camera 196 may be an infrared (IR) camera, e.g., may be operable to receive and record or capture images based on infrared light. The one or more cameras 192, 196 may be mounted to cabinet 120, to fresh food doors 128, or otherwise positioned in view of fresh food chamber 122, and/or an area in front of the cabinet 120 that is contiguous with the fresh food chamber 122. As shown in FIG. 3, a camera 192 of camera assembly 190 is mounted to cabinet 120 at the front opening 148 of fresh food chamber 122 and is oriented to have a field of view 194 directed across the front opening and/or into fresh food chamber 122 and in front of the fresh food chamber 122. As shown in FIG. 4, each camera 192 (of the two cameras 192 in this embodiment) is mounted to cabinet 120 at a respective front opening of fresh food chamber 122 and freezer chamber 124, such that each camera 192 is oriented to have a field of view 194 directed across the front opening and/or into each respective food storage chamber and in front of the fresh food chamber 122 and freezer chamber 124. The structure and operation of cameras are understood by those of ordinary skill in the art and, as such, the camera is not specifically illustrated or described in further detail herein for the sake of brevity and clarity.

Although a single camera 192 is illustrated in FIG. 3, it should be appreciated that camera assembly 190 may include a plurality of cameras 192 positioned within cabinet 120, wherein each of the plurality of cameras 192 has a specified monitoring zone or range positioned in and/or around refrigerator appliance 100, such as multiple cameras in one or both of the fresh food chamber 122 and the freezer chamber 124. In this regard, for example, the field of view 194 of each camera 192 may be limited to or focused on a specific area. For instance, in the exemplary embodiment illustrated in FIG. 4, the exemplary side-by-side configuration includes one camera 192 for each of the fresh food chamber 122 and the freezer chamber 124.

In some embodiments, it may be desirable to activate the visible light camera or cameras 192 for limited time durations and only in response to certain triggers. For example, the IR camera, e.g., second camera 196, may be always on and may serve as a proximity sensor, such that the photo camera(s) 192 are only activated after the IR camera 196 detects motion at the front of the refrigerator appliance 100. In additional embodiments, the activation of the first camera(s) 192 may be in response to a door opening, such as detecting that the door was opened using a door switch. In this manner, privacy concerns related to obtaining images of the user of the refrigerator appliance 100 may be mitigated. According to exemplary embodiments, camera assembly 190 may be used to facilitate an object detection and/or identification process for refrigerator appliance 100. As such, each camera 192 may be positioned at the front opening 148 to fresh food chamber 122 to monitor one or more doors 128 and/or 130 and adjoining areas, such as while food items are being added to or removed from fresh food chamber 122 and/or freezer chamber 124.

It should be appreciated that according to alternative embodiments, camera assembly 190 may include any suitable number, type, size, and configuration of camera(s) 192 for obtaining images of any suitable areas or regions within or around refrigerator appliance 100. In addition, it should be appreciated that each camera 192 may include features for adjusting the field of view and/or orientation.

It should be appreciated that the images obtained by camera assembly 190 may vary in number, frequency, angle, resolution, detail, etc. in order to improve the clarity of the particular regions surrounding or within refrigerator appliance 100. In addition, according to exemplary embodiments, controller 134 may be configured for illuminating the chilled chamber (e.g., one or both of fresh food chamber 122 and freezer chamber 124) using one or more light sources prior to obtaining images. Notably, controller 134 of refrigerator appliance 100 (or any other suitable dedicated controller) may be operatively or communicatively coupled to camera assembly 190 and may be programmed or configured for analyzing the images obtained by camera assembly 190, e.g., in order to detect and/or identify a objects of interest in or proximate to the refrigerator appliance 100.

In general, controller 134 may be operably coupled to camera assembly 190 for analyzing one or more images obtained by camera assembly 190 to extract useful information regarding objects or people within the field of view of the one or more cameras 192 and/or 196. This analysis may be performed locally (e.g., on controller 134) or may be transmitted to a remote server (e.g., in the “cloud,” as those of ordinary skill in the art will recognize as referring to a remote server or database in a distributed computing environment including at least one remote computing device) for analysis. Such analysis is intended to facilitate detection of food items or other objects of interest, e.g., by identifying food items added to or removed from the fresh food chamber 122 and/or freezer chamber 124.

Specifically, according to an exemplary embodiment as illustrated in FIG. 3, camera 192 (or multiple cameras 192 in the camera assembly 190 collectively) may be oriented down from a top center of cabinet 120 and define a field of view 194 (e.g., as shown schematically in FIG. 3) that covers a width of fresh food chamber 122. In this manner, the field of view 194 of camera 192, and the resulting images obtained, may capture any motion or movement of an object (e.g., food item) placed into and/or out of the fresh food chamber 122 and/or freezer chamber 124. The images obtained by camera assembly 190 may include one or more still images, one or more video clips, or any other suitable type and number of images suitable for detection and/or identification of an object of interest, e.g., a food item.

Notably, camera assembly 190 may obtain images upon any suitable trigger, such as a time-based imaging schedule where camera assembly 190 periodically images and monitors the field of view, e.g., in and/or in front of the refrigerator appliance 100. According to still other embodiments, camera assembly 190 may periodically take low-resolution images until motion (such as opening of one or more doors 128 or 130) is detected (e.g., via image differentiation of low-resolution images), at which time one or more high-resolution images may be obtained. According to still other embodiments, refrigerator appliance 100 may include one or more motion sensors (e.g., optical, acoustic, electromagnetic, etc.) that are triggered when an object or user moves into or through the area in front of the refrigerator appliance 100, and camera assembly 190 may be operably coupled to such motion sensors to obtain images of the object during such movement. As will be described below, according to still other embodiments, controller 134 may receive a verbal input, e.g., from a user, with one or more activation or wake words. For example, the controller 134 may receive the verbal input from a microphone 135 of the user interface panel 136, and/or the like. Thereafter, the controller 134 may activate the camera assembly 190, e.g., from a standby mode, such that camera assembly 190 takes low-resolution and/or high-resolution images and/or the controller 134 may illuminate one or more chilled chamber lights (not shown) within one or more chilled chambers of the refrigerator appliance 100 to provide light for the camera assembly 190.

It should be appreciated that the images obtained by camera assembly 190 may vary in number, frequency, angle, resolution, detail, etc. in order to improve the clarity thereof. In addition, according to exemplary embodiments, controller 134 may be configured for illuminating the refrigerator light(s) while obtaining the image or images. Other suitable imaging triggers are possible and within the scope of the present subject matter.

Using the teachings disclosed herein, one of skill in the art will understand that the present subject matter can be used with other types of refrigerators such as a refrigerator/freezer combination, side-by-side, bottom mount, compact, and any other style or model of refrigerator appliance. Accordingly, other configurations of refrigerator appliance 100 could be provided, it being understood that the configurations shown in the accompanying figures and the description set forth herein are by way of example for illustrative purposes only.

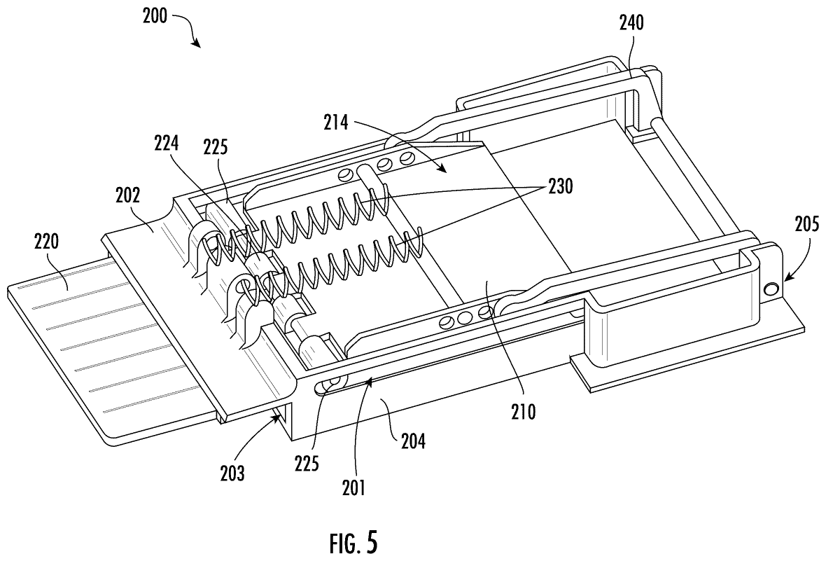

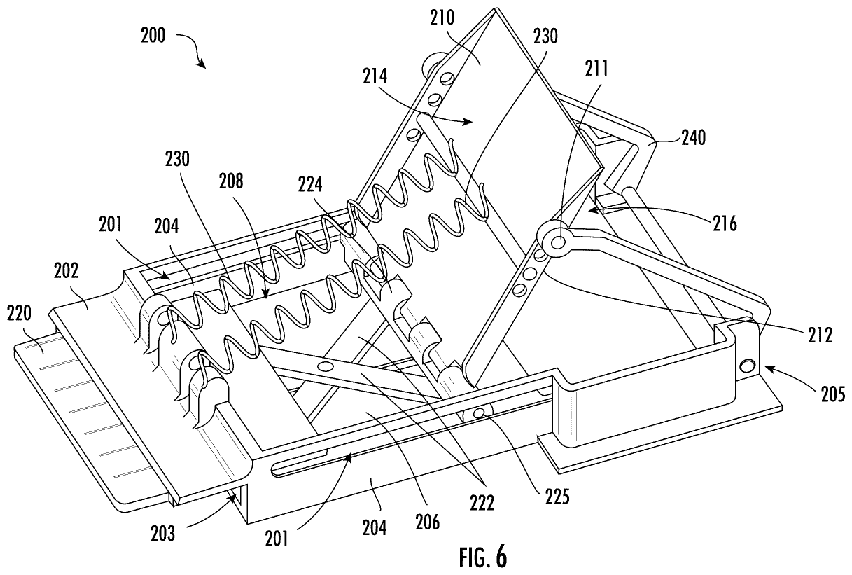

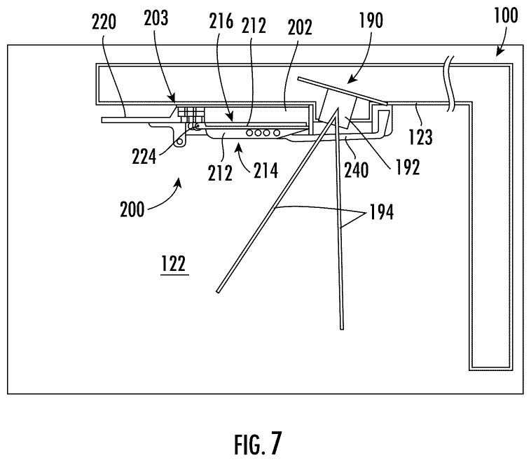

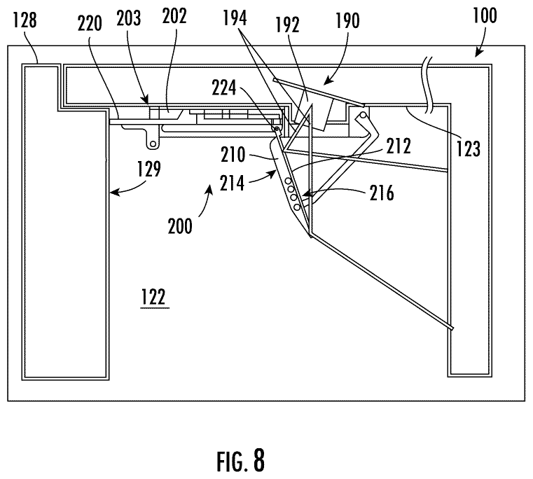

Referring now to FIGS. 5 through 8, various views of a mirror assembly 200 for use with a refrigerator appliance, such as refrigerator appliance 100, are provided. Specifically, FIGS. 5 and 6 provide perspective views of the mirror assembly 200 in a retracted position and a fully extended position respectively. FIGS. 7 and 8 provide side partially cross-sectional views of the refrigerator appliance 100 with the mirror assembly 200 mounted within the refrigerator appliance 100 and shown in the retracted position and the fully extended position respectively.

According to some example embodiments, the mirror assembly 200 may include a frame 202. The frame 202 may include one or more walls, such as a pair of opposing side walls 204 that extend orthogonally from a base wall 206. The pair of opposing side walls 204 and the base wall 206 (FIG. 6) may collectively define a chamber 208 (FIG. 6) within which, as will be described below, a mirror plate of the mirror assembly 200 may be positioned when retracted. As described herein, the frame 202 may be an anchor point upon which other components of the mirror assembly 200 are coupled or attached to. Additionally, the frame 202 may be coupled or mounted on a location within the refrigerator appliance 100, such within fresh food chamber 122 and/or within freezer chamber 124. For example, a ceiling 123 (FIGS. 7-8) may define and bound fresh food chamber 122. The ceiling 123 may be the vertical most boundary within the fresh food chamber 122. In some embodiments, the frame 202 may be mounted or coupled to the ceiling 123 within the fresh food chamber 122. In this respect, the mirror assembly 200 may be mounted or coupled to the ceiling 123 and positioned within the fresh food chamber 122.

According to some example embodiments, the mirror assembly 200 includes a mirror plate 210 with a mirror 212 mounted thereon. The mirror plate 210 may include a bottom (first) side 214 and a top (second) side 216 that is opposite the bottom side 214, e.g., in the vertical direction V while the mirror plate 210 is in a retracted position as described hereinbelow. The mirror 212 may be mounted on the mirror plate 210 on the top side 216 of the mirror plate 210.

Notably, the mirror plate 210 may be movable such that the mirror 212 is positioned within the field of view 194 of a camera, e.g., camera 192 and/or camera 196, of camera assembly 190. In this respect, the mirror 212 may provide a reflected image to the camera of at least a portion of the chilled chamber, e.g., fresh food chamber 122, within which the mirror assembly 200 and the camera assembly 190 are positioned. As such, the camera may view a portion of the chilled chamber and capture images of the portion of the chilled chamber from the mirror 212 that it may otherwise not be positioned to view. In this respect, the mirror 212 may provide the camera with one or more viewing angles of the chilled chamber without moving or changing the position of the camera.

According to some example embodiments, the mirror assembly 200 may include an actuator 220 that is operably coupled to the mirror plate 210. The actuator 220 may be movable, which moves the mirror plate 210 between a retracted position in which the mirror plate 210 is nested within the chamber 208 of the frame 202, e.g., between the pair of opposing side walls 204, and a fully extended position in which the mirror plate 210 protrudes out of the frame 202 and the mirror 212 is positioned within the field of view 194 of the camera of the camera assembly 190 as described above. The mirror plate 210 may also be moved to any one of a plurality of partially extended positions between the retracted position and the fully extended position. In some embodiments, the actuator 220 may take the form of an actuator plate or panel 220. The actuator panel 220 may be received through a panel aperture 203 defined through the frame 202 of the mirror assembly 200, such as between the pair of opposing side walls 204 described above. The panel aperture 203 may bound the actuator panel 220 on a top, bottom, and lateral sides, thus constraining movement of the actuator panel along a single linear direction, e.g., the transverse direction T.

As best illustrated in FIGS. 7 and 8, in some embodiments, the mirror assembly 200 may be positioned such that one or more doors, e.g., fresh food door(s) 128, of the refrigerator appliance 100, particularly an interior side 129 of the fresh food door(s) 128, which faces the fresh food chamber 122 while the fresh food door(s) 128 is closed, may contact or push the actuator panel 220 inward along the single linear direction, e.g., the transverse direction T, as the fresh food door(s) 128 is closed. For example, the mirror assembly 200 may be positioned within fresh food chamber 122, e.g., at a top of fresh food chamber 122, and oriented such that the actuator panel 220 is aligned with the interior side 129 of fresh food door(s) 128 while fresh food door(s) 128 is closed and protrudes out of the cabinet 120 while fresh food door(s) 128 is open. While the fresh food door(s) 128 is closed, the fresh food door(s) 128 may continue to contact the actuator panel 220, thus holding the mirror plate 210 in the fully extended position. As will be described below, one or more biasing elements may bias the mirror plate 210 toward the retracted position such that, as the fresh food door(s) 128 are opened, the actuator panel 220 is moved outward along the single linear direction, e.g., the transverse direction T.

As best illustrated in FIG. 6, the actuator panel 220 may be coupled to and operable to expand and retract a pair of scissor arms 222 of the mirror assembly 200 as the fresh food door(s) 128 is opened and closed. The pair of scissor arms 222 may be coupled to the actuator panel 220 at one end of the scissor arms 222 and may be expandable and retractable along the single linear direction, e.g., the transverse direction T, with movement of the actuator panel 220 along the single linear direction. The scissor arms 222 may also be fixedly coupled to a hinge 224 at an opposite end of the scissor arms 222 from the actuator panel 220. The frame 202 of the mirror assembly 200 may define one or more linear slots 201, such as a pair of linear slots 201 each of which extends along the single linear direction, e.g., the transverse direction T, on opposite sides of the frame 202. The hinge 224 may include a pair of guides 225 on opposite sides thereof that are received within the pair of linear slots 201. As the actuator panel 220 expands or retracts the pair of scissor arms 222, the pair of guides 225 of the hinge 224 are guided along the pair of linear slots 201 by boundaries of the pair of linear slots 201. In this respect, the hinge 224 is moved with the pair of scissor arms 222 along the single linear direction. The mirror plate 210 may be rotatably coupled to the hinge 224 and, thus, rotatable about the hinge 224, such as during expansion or retraction of the pair of scissor arms 222. In this respect, the pair of scissor arms 222 may move the mirror plate 210 between the fully extended position and the retracted position as movement of the fresh food door(s) 128 between opened and closed moves the actuator panel 220.

According to some example embodiments, the mirror plate 210 may be coupled to the frame 202 of the mirror assembly 200. For example, the mirror assembly 200 may include one or more biasing elements 230, such as a pair of springs 230. The pair of springs 230 may be coupled between the frame 202 and the mirror plate 210, e.g., to the bottom side 214 thereof. As the mirror plate 210 is moved away from the retracted position as described above, the pair of springs 230 may extend and, thus, apply a force to the bottom side 214 of the mirror plate 210 and bias the mirror plate 210 about the hinge 224 toward the retracted position. As such, during opening of the fresh food door(s) 128, the mirror plate 210 may be rotated about the hinge 224 toward the frame 202/toward the retracted position by the pair of springs 230.

According to some example embodiments, the mirror assembly 200 may also include a rotatable arm structure 240. The rotatable arm structure 240 may be coupled between the mirror plate 210, such as to a plate pivot joint 211 (FIG. 6) thereof, and the frame 202, such as to a frame pivot joint 205 thereof. The rotatable arm structure 240 may be coupled to a side of the frame 202 opposite of the hinge 224. In this respect, the rotatable arm structure 240 applies force to the plate pivot joint 211 as the mirror plate 210 is moved away from the retracted position, thereby biasing the mirror plate 210 about the hinge 224 toward the fully extended position.

Now that the construction of an exemplary refrigerator appliance and the configuration of controller 134 according to exemplary embodiments have been presented, an exemplary method of operating a refrigerator appliance will be described. In exemplary embodiments, the various method steps as disclosed herein may be performed locally, e.g., by controller 134, and/or a separate, dedicated controller integrated into the refrigerator appliance 100. Furthermore, some or all of the various method steps may be performed remotely, e.g., in a distributed computing environment such as the cloud, fog, or edge, wherein the controller 134 communicates with one or more remote computing devices of the distributed computing environment, such as data processing and/or analysis, may be performed in the cloud and the output of such process may be transmitted to and received by the refrigerator appliance 100, such as by the controller 134 thereof.

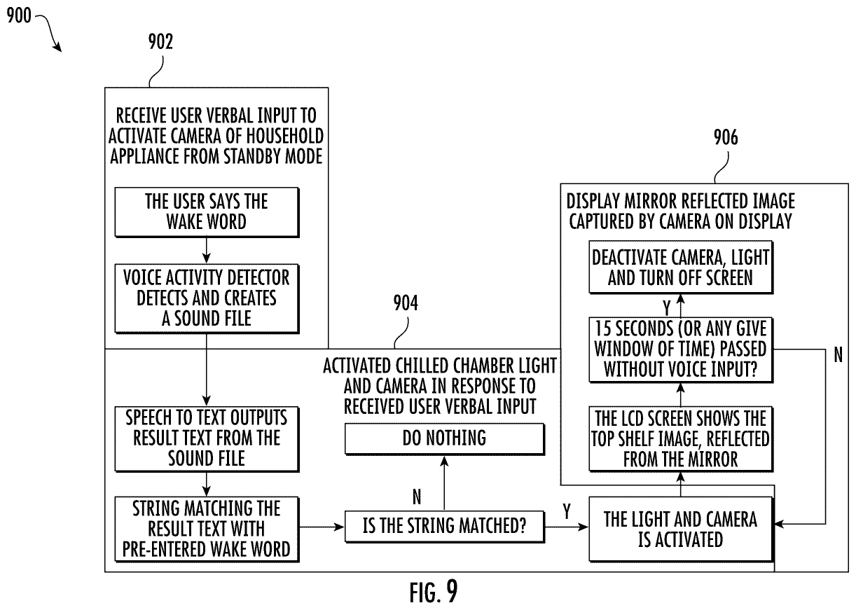

As illustrated in FIG. 9, embodiments of the present disclosure also include methods of operating a refrigerator appliance, where the refrigerator appliance may be the refrigerator appliance 100 described above. Further, methods of operating a refrigerator appliance according to the present disclosure are not necessarily limited to the exemplary appliance described or illustrated. For example, the refrigerator appliance may include various combinations of chilled chambers as in any of the foregoing examples, such as a refrigerator/freezer appliance with only one chilled chamber, among numerous other possible combinations.

Exemplary methods according to the present subject matter include method 900 of operating a refrigerator appliance illustrated in FIG. 9. As illustrated in FIG. 9, the method 900 includes receiving a user verbal input to activate a camera of a household appliance from a standby mode, e.g., as indicated at (902) in FIG. 9. Specifically, a controller, such as the controller 134 of the refrigerator appliance 100, may receive the user verbal input to activate the camera assembly 190 from standby mode. For example, the user interface panel 136 described above may receive the user verbal input via the microphone 135. Thereafter, the controller 134 may receive the user verbal input from the user interface panel 136. However, it should be appreciated that the controller 134 may receive the user verbal input in any other suitable manner, such as from a remote user interface device, e.g., smartphone device. In some embodiments, the controller may further create a sound or audio file, which serves as an input to a model, such as a Speech-to-Text model. As such, the controller may input the created sound or audio file into the Speech-to-Text model. As will be described below, the Speech-to-Text model may utilize the created sound/audio file to generate or output a result text of the created sound/audio file. As described herein, the user verbal input may be a wake word or set of wake words intended to activate the camera assembly 190 from the standby mode. The standby mode may be a deactivated or sleep mode in which the camera assembly 190 does not capture images or captures low-resolution images only.

Additionally, the method 900 includes activating a chilled chamber light within a chilled chamber of the refrigerator appliance and the camera from the standby mode in response to the received user verbal input, whereby the camera captures one or more images reflected by a mirror of a mirror assembly of the household appliance, e.g., as indicated at (904) in FIG. 9. Specifically, the controller 134 may activate the camera assembly 190 of the refrigerator appliance 100 and a chilled chamber light of fresh food chamber 122, e.g., for illuminating fresh food chamber 122, from standby mode in response to the user verbal input received at (902). For example, the mirror plate 210 may be in the fully extended position as described above. In this respect, the mirror 212 may be positioned within the field of view 194 of the camera assembly 190 and, thus, when activated, the camera assembly 190 may capture one or more images, e.g., still images, video, of the chilled chamber, e.g., fresh food chamber 122, reflected by the mirror 212 of the mirror assembly 200.

In some embodiments, activating the camera from the standby mode may include generating a text output from the user verbal input received at (902). For example, the controller 134 may convert audio verbal input into a text output, e.g., a machine-readable text file, such as by utilizing the Speech-to-Text model to generate and output text of the created sound/audio filed described above. The controller 134 may then compare the generated text output to a predetermined text string. For example, the text string may be stored within the memory of the controller 134. Thereafter, the controller 134 may either activate the camera assembly 190 in response to the generated text output matching the predetermined text string or do nothing in response to the generated text output not matching the predetermined text string. For example, the controller 134 may determine that the generated text output matches, e.g., the same as or generally the same as, the predetermined text string and, as a result, activate the camera assembly 190.

Moreover, the method 900 includes displaying mirror reflected images that are captured by the camera on a display of the household appliance, e.g., as indicated at (906) in FIG. 9. Specifically, the mirror reflected images captured by the activated camera assembly 190 may be displayed on the display of the user interface panel 136, e.g., LCD touchscreen thereof. The displayed mirror reflected image may include at least a portion of a top shelf of the refrigerator appliance 100. A timer may begin a countdown once the camera assembly 190 and/or the chilled chamber light have been activated. Thereafter, once the timer reaches a predetermined length of time, e.g., approximately 15 seconds, without any voice input, the controller may deactivate one or both of the camera assembly 190 or the chilled chamber light, e.g., into standby mode. In this respect, there may be no mirror reflected images displayed due to one or both of the camera assembly 190 being in standby mode or the chilled chamber not being illuminated. However, alternatively, when verbal input is received within the predetermined length of time, the timer resets and one or both of the camera assembly 190 or the chilled chamber light remain activated for the predetermined length of time unless additional verbal input is received.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a chilled chamber;
a door rotatably hinged to the cabinet to provide selective access to the chilled chamber;
a camera mounted to the cabinet, whereby the camera captures one or more images of the chilled chamber upon activation; and
a mirror assembly positioned within the chilled chamber, the mirror assembly comprising:
a frame;
a mirror plate including a mirror mounted thereon, the mirror plate coupled to the frame, the mirror plate movable between a retracted position in which the mirror plate is nested within the frame and a fully extended position in which the mirror plate protrudes out of the frame;
an actuator operably coupled to the mirror plate and contacted by the door while the door is closed, whereby movement of the door moves the actuator; and
a pair of scissor arms coupled between the mirror plate and the actuator, whereby the pair of scissor arms moves the mirror plate between the fully extended position and the retracted position as movement of the door moves the actuator.

2. The refrigerator appliance of claim 1, the mirror assembly further comprising:
a hinge coupled between the mirror plate and the pair of scissor arms, whereby the mirror plate is rotatable about the hinge during movement of the mirror plate between the fully extended position and the retracted position as the pair of scissor arms move the hinge.

3. The refrigerator appliance of claim 2, the mirror assembly further comprising:
a rotatable arm structure coupled to a pivot joint on the mirror plate and a pivot joint on the frame, whereby the rotatable arm structure applies force to the pivot joint on the mirror plate as the mirror plate is moved away from the retracted position thereby biasing the mirror plate about the hinge toward the fully extended position.

4. The refrigerator appliance of claim 2, wherein:
the frame defines a linear slot, wherein a portion of the hinge is received in the linear slot, whereby collective movement of the actuator, the scissor arms, and the hinge is guided by the linear slot along a linear direction during movement of the door.

5. The refrigerator appliance of claim 2, the mirror assembly further comprising:
a biasing element coupled between the mirror plate and the frame, whereby the biasing element biases the mirror plate about the hinge toward the retracted position.

6. The refrigerator appliance of claim 5, wherein:
the mirror plate further comprises a first side and a second side opposite the first side, the mirror mounted on the first side of the mirror plate; and
the biasing element is coupled between the frame and the second side of the mirror plate, whereby the biasing element is extended as the mirror plate is moved away from the retracted position thereby biasing the mirror plate about the hinge toward the retracted position.

7. The refrigerator appliance of claim 1, wherein:
the chilled chamber is bounded by a ceiling that defines a vertical most boundary within the chilled chamber; and
the mirror assembly is mounted on the ceiling.

8. The refrigerator appliance of claim 1, further comprising:
a user interface including a microphone for receipt of a user verbal input; and
a controller operatively coupled to the user interface and the camera, the controller configured for:
receiving the user verbal input; and
activating the camera in response to the received user verbal input, whereby the camera captures one or more images of the chilled chamber reflected by the mirror.

9. The refrigerator appliance of claim 8, wherein activating the camera comprises:
generating a text output from the received user verbal input;
comparing the generated text output to a predetermined text string; and
activating the camera in response to the generated text output matching the predetermined text string.

10. A refrigerator appliance, comprising:
a cabinet defining a chilled chamber;
a door rotatably hinged to the cabinet to provide selective access to the chilled chamber;
a camera mounted to the cabinet, whereby the camera captures one or more images of the chilled chamber upon activation; and
a mirror assembly positioned within the chilled chamber, the mirror assembly comprising:
a frame defining a linear slot;
a mirror plate including a mirror mounted thereon, the mirror plate coupled to the frame, the mirror plate movable between a retracted position in which the mirror plate is nested within the frame and a fully extended position in which the mirror plate protrudes out of the frame; and
an actuator operably coupled to the mirror plate and contacted by the door while the door is closed, whereby the actuator guided by the linear slot along a linear direction during movement of the door.

11. The refrigerator appliance of claim 10, the mirror assembly further comprising:
a pair of scissor arms coupled between the mirror plate and the actuator, whereby the pair of scissor arms move the mirror plate between the fully extended position and the retracted position as movement of the door moves the actuator.

12. The refrigerator appliance of claim 11, the mirror assembly further comprising:
a hinge coupled between the mirror plate and the pair of scissor arms, whereby the mirror plate is rotatable about the hinge during movement of the mirror plate between the fully extended position and the retracted position as the pair of scissor arms move the hinge.

13. The refrigerator appliance of claim 12, the mirror assembly further comprising:
a rotatable arm structure coupled to a pivot joint on the mirror plate and a pivot joint on the frame, whereby the rotatable arm structure applies force to the pivot joint on the mirror plate as the mirror plate is moved away from the retracted position thereby biasing the mirror plate about the hinge toward the fully extended position.

14. The refrigerator appliance of claim 12, wherein:
a portion of the hinge is received in the linear slot of the frame, whereby collective movement of the actuator, the scissor arms, and the hinge is guided by the linear slot along the linear direction during movement of the door.

15. The refrigerator appliance of claim 12, the mirror assembly further comprising:
a biasing element coupled between the mirror plate and the frame, whereby the biasing element biases the mirror plate about the hinge toward the retracted position.

16. The refrigerator appliance of claim 15, wherein:
the mirror plate further comprises a first side and a second side opposite the first side, the mirror mounted on the first side of the mirror plate; and
the biasing element is coupled between the frame and the second side of the mirror plate, whereby the biasing element is extended as the mirror plate is moved away from the retracted position thereby biasing the mirror plate about the hinge toward the retracted position.

17. The refrigerator appliance of claim 10, wherein:
the chilled chamber is bounded by a ceiling that defines a vertical most boundary within the chilled chamber; and
the mirror assembly is mounted on the ceiling.

18. The refrigerator appliance of claim 10, further comprising:
a user interface including a microphone for receipt of a user verbal input; and
a controller operatively coupled to the user interface and the camera, the controller configured for:
receiving the user verbal input; and
activating the camera in response to the received user verbal input, whereby the camera captures one or more images of the chilled chamber reflected by the mirror.

19. The refrigerator appliance of claim 18, wherein activating the camera comprises:
generating a text output from the received user verbal input;
comparing the generated text output to a predetermined text string; and
activating the camera in response to the generated text output matching the predetermined text string.
